(19) United States
(12) Patent Application Publication
(10) Pub. No.: US 2014/0365230 A1
(43) Pub. Date: Dec. 11, 2014

(54) METHOD AND APPARATUS FOR MAXIMIZING A LIMITED SET OF IDENTIFIERS FOR AUDIO WATERMARKING

(71) Applicant: THOMSON LICENSING, Issy de Moulineaux (FR)

(72) Inventor: Mark Leroy Walker, Los Angeles, CA (US)

(21) Appl. No.: 13/915,355

(22) Filed: Jun. 11, 2013

(51) Int. Cl. G10L 19/018

(52) U.S. Cl. CPC G10L 19/018
USPC 704/500

(57) ABSTRACT

A method and apparatus for encoding identifiers into a media item, the method including: embedding a sequence of identifiers equally and in order over a duration of a content of the media item; and storing a mapping between the embedded identifiers and the media item; wherein the sequence of identifiers is created by: (a) generating a subsequence of 2M unique identifiers, M being an integer greater than one; (b) shifting every other identifiers in the generated subsequence to the right by two positions in the subsequence and with the identifier at the end cycling around to the corresponding position at the beginning to generate a new subsequence; (c) repeating step (b) up to M−1 times; and (d) concatenating the generated subsequences to create the sequence of identifiers.

### TECHNICAL FIELD

This invention relates to audio watermarking, and more particularly to a method and apparatus to maximize the use of a limited set of audio watermark IDs to uniquely identify media items along with specific positions within the media.

### BACKGROUND ART

Audio watermark identifiers are encoded into the audio of a media item and are used, in this case, to synchronize second screen content to the primary media playback. Identifiers are directly mapped to discrete second-screen events (e.g. a trivia information event on an actor that is currently appearing on screen) or these identifiers can be mapped to specific time locations that drive a separate clock which is in-turn used to drive display of second-screen events which are mapped to time (indirect mapping of events via the clock).

Current technology uses 8-bit identifiers and takes a minimum of approximately 6 seconds to decode from the audio stream. This affords the use of up to 256 unique identifiers for specifying events and/or positions in time for a given piece of content. While this is manageable (albeit constrained) for a given piece of content there is an additional requirement of being able to uniquely identify individual pieces of content, especially, as an example, in the case of a TV series with multiple episodes across multiple season. This is ignoring, for now, the desire to extend this paradigm to uniquely identify content beyond these boundaries.

Additionally, in the separate clock syncing method mentioned above, it is desirable to have a short time between identifiers so that pauses or commercial breaks in the media can be detected in a responsive manner.

Thus, a need exists for maximizing the use of identifiers in such a way as to support all of the above requirements.

Increasing the bit depth of the identifiers can be used to provide enough uniqueness to be used across multiple media items. However, it comes with a cost. The more bits, the longer the decode times which could result in a loss of responsiveness. The current 8-bit codes provide for 256 unique identifiers, a 10-bit code would provide 1024 unique id's with the assumption that the decode time increases proportionally. With the conservative estimate of an identifier every 20 seconds this allows for only 85 hours (less than two 50-min TV episodes) at 8-bits and only 341 hours (less than 7 50-min episodes) at 10-bits.

Similar second-screen applications specifically query a device service (e.g., BDLive on BluRay Disk) to get a unique identifier of the content when initially connecting (regardless of the current position of the content playback). With audio watermarking there is no such service to query so there needs to be unique information regularly decoded that can be correlated with a specific media item. This means that simple identifiers cannot be reused across multiple media items—they must be unique.

### BRIEF SUMMARY

An embodiment is to take into account the unique sequence of identifiers over time within the content. The identifier sequence is arranged such that no ordered pair of identifiers is ever repeated. The sequence can then be segmented to allocate sections to individual media items.

One embodiment provides a method for encoding identifiers into a media item, the method including: embedding a sequence of identifiers equally and in order over a duration of a content of the media item; and storing a mapping between the embedded identifiers and the media item; wherein the sequence of identifiers is created by: (a) generating a subsequence of 2M unique identifiers, M being an integer greater than one; (b) shifting every other identifiers in the generated subsequence to the right by two positions in the subsequence and with the identifier at the end cycling around to the corresponding position at the beginning to generate a new subsequence; (c) repeating step (b) up to M−1 times; and (d) concatenating the generated subsequences to create the sequence of identifiers.

Another embodiment provides a method for decoding a media item that is embedded with a sequence of identifiers equally and in order over a duration of a content of the media item, the method including: detecting a pair of identifiers within a predetermined time period; retrieving a mapping between the embedded identifiers and the media item; identifying the media item by indexing the detected pair using the mapping between the embedded identifiers and the media item.

Yet another embodiment provides an apparatus for encoding identifiers into a media item, including: an encoder device configured to embed a sequence of identifiers equally and in order over a duration of a content of the media item; and a memory device to store a mapping between the embedded identifiers and the media item; wherein the sequence of identifiers is created by: (a) generating a subsequence of 2M unique identifiers, M being an integer greater than one; (b) shifting every other identifiers in the generated subsequence to the right by two positions in the subsequence and with the identifier at the end cycling around to the corresponding position at the beginning to generate a new subsequence; (c) repeating step (b) up to M−1 times; and (d) concatenating the generated subsequences to create the sequence of identifiers.

Yet another embodiment provides an apparatus for decoding a media item that is embedded with a sequence of identifiers equally and in order over a duration of a content of the media item, the apparatus comprising: a memory device to store a mapping between the embedded identifiers and the media item; a decoder device configured to detect a pair of identifiers within a predetermined time period, and to identify the media item by indexing the detected pair using the mapping between the embedded identifiers and the media item.

Objects and advantages will be realized and attained by means of the elements and couplings particularly pointed out in the claims. It is important to note that the embodiments disclosed are only examples of the many advantageous uses of the innovative teachings herein. It is to be understood that both the foregoing general description and the following detailed description are exemplary and explanatory and are not restrictive of the invention, as claimed. Moreover, some statements may apply to some inventive features but not to others. In general, unless otherwise indicated, singular elements may be in plural and vice versa with no loss of generality. In the drawings, like numerals refer to like parts through several views.

### BRIEF SUMMARY OF THE DRAWINGS

FIG. 1 depicts a block schematic diagram of an apparatus for encoding identifiers into media items according to an embodiment.

FIG. 2 depicts a block schematic diagram of an apparatus for decoding media items according to an embodiment.

FIG. 3 depicts the generation of a sequence of identifiers according to an embodiment.

FIG. 4 depicts the mapping of watermarks to audio tracks of media items according to an embodiment.

### DETAILED DESCRIPTION

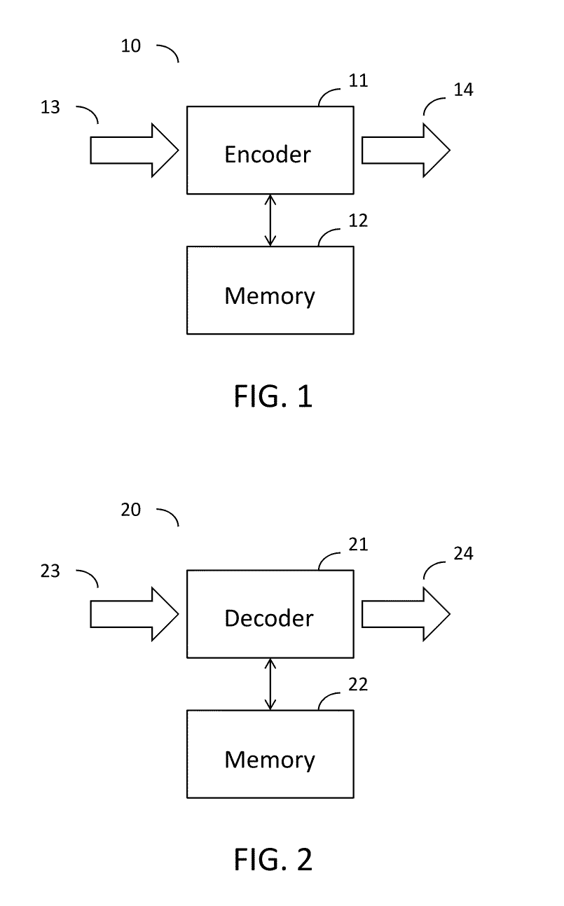

FIG. 1 depicts a block schematic diagram of an exemplary device 10, capable of embedding identifiers into media items. The device 10 includes an encoder 11 that encodes the identifiers or watermarks into a media item, for example an audio stream 13. Each watermark is a unique identifier that can be mapped to a particular time location in a known playback of media. A mapping between the identifiers and the particular time location is stored in a memory device 12 (e.g., volatile or non-volatile memory, including RAM, SRAM, DRAM, ROM, programmable ROM (PROM), flash memory, electronically programmable ROM (EPROM) , electronically erasable programmable ROM (EEPROM), etc.). An encoded stream 14 is outputted and will be decoded by an exemplary device 20 shown in FIG. 2.

FIG. 2 depicts a block schematic diagram of an exemplary device 20, capable of extract identifiers from an encoded media items. The device 20 includes a decoder 21 that decodes the identifiers or watermarks from an encoded media item, for example, an encoded audio stream 23. Each watermark is a unique identifier that can be mapped to a particular time location in a known playback of media. When decoding, the decoder 21 access a mapping between the identifiers and the particular time location stored in a memory device 22 to create a decoded output 24.

An application is to have a tablet device (2nd screen) detect the watermarks embedded in a stream of audio being played back by a TV (could be other playback devices) in order to synchronize playback of content on the second screen with that of the primary screen (TV). Each watermark is a unique identifier that can be mapped to a particular time location in a known playback of media. A problem to be solved is that the number of bits used for the watermarks are not sufficient to uniquely map to a particular piece of content and a particular location of time within that content. For example, trying to assign 255 unique ID's every 10 seconds for thousands of videos would be unsatisfactory.

As discussed before, one existing solution is to simply increase the bits used to encode the watermark. However, it takes longer decode between watermarks which in-turn can affect the synchronization response time.

One embodiment provides a way to minimize the decode time between watermarks (providing more responsive synchronization) while providing a way to establish uniqueness across multiple pieces of media. In this case the embodiment proposes replacing uniqueness of individual watermarks with the uniqueness of watermark combinations.

In general, 2M (M=positive integer greater than one) unique identifiers are used to create unique watermark combinations. Without loss of generality, 8-bit identifiers are used as an example below to demonstrate the sequence generation process.

An exemplary method for generating this sequence is thus:

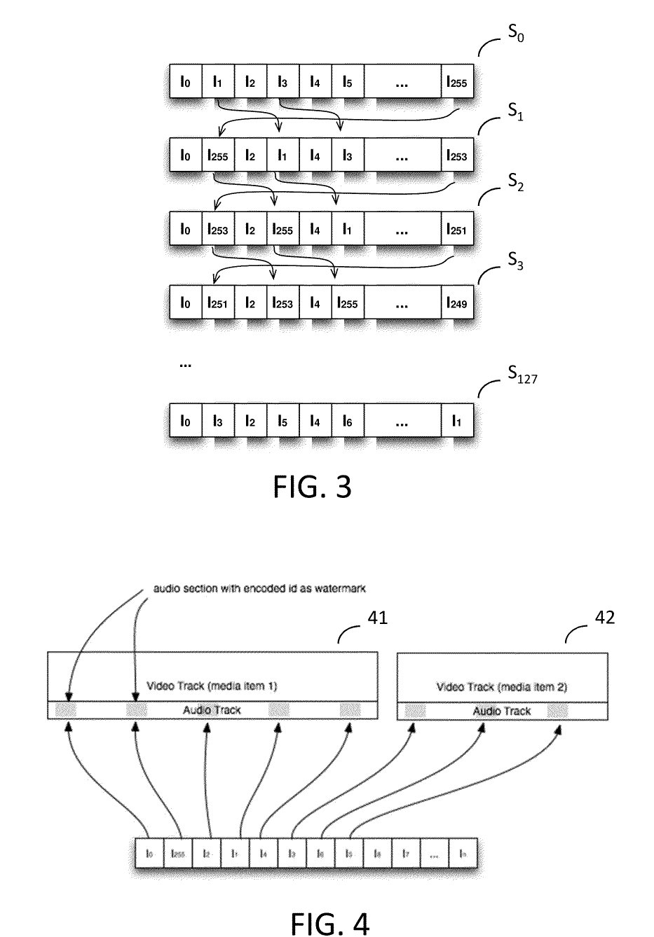

Given an 8-bits per identifier there are 256 unique possibilities. As shown in FIG. 3, the identifiers (I) are arranged in order from lowest to highest to create the first set of values (first sub-sequence of identifiers). The first sub-sequence is:

S₀=I₀, I₁, I₂, I₃, I₄, I₅, . . . , I₂₅₅

Every odd item is shifted two positions to the right with the items at the end cycling around to the corresponding position at the beginning to create another set. (Note that in this example, the odd items are shifted. Shifting the even items is also contemplated.) The next sub-sequence is generated as:

S₁=I₀, I₂₅₅, I₂, I₁, I₄, I₃, . . . , I₂₅₃

This iterative process is continued until just before the cycle repeats in order to generate all the sets.

$${S}_{2} = {I}_{0} , {I}_{253} , {I}_{2} , {I}_{255} , {I}_{4} , {I}_{1} , … , {I}_{251}$$

$${S}_{3} = {I}_{0} , {I}_{251} , {I}_{2} , {I}_{253} , {I}_{4} , {I}_{255} , … , {I}_{249}$$

$$…$$

$${S}_{127} = {I}_{0} , {I}_{3} , {I}_{2} , {I}_{5} , {I}_{4} , {I}_{7} , … , {I}_{1}$$

Given an original sub-sequence of 256 identifiers, half that number of sets (128) can be created before the cycle repeats. Therefore, in this example, there are 128 sub-sequences of identifiers. We create a sequence (or master sequence) by concatenating these generated sets:

S_{Master}=S₀, S₁, S₂, S₃, S₄, S₅, . . . , S₁₂₇

Note that the above example only illustrated one order of concatenation based on the order of generation of the sub-sequences. Other concatenations or partial concatenations of the generated sub-sequences are also contemplated.

In the case of 8-bit codes (above), it results in 256*128=32,768 identifiers arranged such that each pair is unique. Note that unique paring is relative to every identifier not just the odd or even ones. In this embodiment, the second identifier in a unique pair becomes the first identifier for the next unique pair.

This approach can be generalized such that an identifier of bit-depth n will produce a master sequence of 2⁽²ⁿ⁻¹⁾ identifiers arranged with unique paring between identifiers.

Allocating Segments of the Sequence

In one embodiment, contiguous sections of the (master) sequence are allocated to a media items. Identifiers are embedded equally and in order over the duration of the content. As sections are allocated they are no longer available for use.

As an example, FIG. 4 shows how the identifiers are mapped into the audio tracks of two media items 41 and 42. Each of the media item contains a video track and an audio track. In this case, five identifiers (e.g., I₀, I₂₅₅, I₂, I₁, I₄) are sequentially embedded into the audio track of the first media item 41 and then the next three identifiers (e.g., I₃, I₆, I₅) are sequentially embedded into the audio track of the second media item 42.

As sections of identifiers are used the section is mapped to the media item and this relationship is stored in a data repository. No reuse of sections is allowed. This repository, or a subset thereof, is subsequently used in the detection process.

Efficiency

An embodiment extends the use of smaller codes by allowing reuse of identifiers in a unique way. As an example: if an identifier is encoded every 10 seconds in a media item using an 8-bit code, the 256 identifiers would only accommodate 42-minutes of content. By using the method in the above embodiment, those same codes can be applied across 91 hours of content.

Detection

In one embodiment, identifiers are used for two purposes:
pairs of identifiers uniquely identify the media item.
individual identifiers (with some exceptions) provide synchronization Information—i.e. the ids are mapped to know locations in time within the media item.

To detect a unique media item, two identifiers must be detected within the expected timeframe (this avoids the possibility of missing detections and producing an erroneous match) and the resulting pair is used to index into the map previously created during allocation.

Detecting sync points requires a media specific map of identifiers to time locations. As an identifier is detected the id-to-time map is referenced to determine the current point within the media. A special case occurs when a given identifier appears more than once within a particular media item. In this case the id can be ignored or coupled with the previous or next identifier to determine the current sync point.

Note that in the above embodiment that only odd identifiers are “shifted,” the constant or “un-shifted” sequence of even identifiers can be used for other decoding optimizations.

The various embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the embodiments and the concepts contributed by the inventor to furthering the art, and are to be construed as being without limitation to such specifically recited examples and conditions. Moreover, all statements herein reciting principles, aspects, and varies embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A method for encoding identifiers into a media item, comprising:
embedding a sequence of identifiers equally and in order over a duration of a content of the media item; and
storing a mapping between the embedded identifiers and the media item;
wherein the sequence of identifiers is created by:
(a) generating a subsequence of 2M unique identifiers, M being an integer greater than one;
(b) shifting every other identifiers in the generated subsequence to the right by two positions in the subsequence and with the identifier at the end cycling around to the corresponding position at the beginning to generate a new subsequence;
(c) repeating step (b) up to M−1 times; and
(d) concatenating the generated subsequences to create the sequence of identifiers.

2. The method according to claim 1, wherein unique pairs of identifiers are formed form the sequence of identifiers, such that the second identifier in a unique pair becomes the first identifier for the next unique pair.

3. The method according to claim 1, wherein the identifiers are mapped to known locations in time within the media item.

4. The method according to claim 1, wherein the sequence of identifiers is segmented to allocate a section of the sequence to an individual media item.

5. The method according to claim 1, wherein the 2M unique identifiers are generated by n-bit codes.

6. A method for decoding a media item that is embedded with a sequence of identifiers equally and in order over a duration of a content of the media item, the method comprising:
detecting a pair of identifiers within a predetermined time period;
retrieving a mapping between the embedded identifiers and the media item;
identifying the media item by indexing the detected pair using the mapping between the embedded identifiers and the media item.

7. The method according to claim 6, wherein the sequence of identifiers is created by:
(a) generating a subsequence of 2M unique identifiers, M being an integer greater than one;
(b) shifting every other identifiers in the generated subsequence to the right by two positions in the subsequence and with the identifier at the end cycling around to the corresponding position at the beginning to generate a new subsequence;
(c) repeating step (b) up to M−1 times; and
(d) concatenating the generated subsequences to create the sequence of identifiers.

8. The method according to claim 7, wherein unique pairs of identifiers are formed form the sequence of identifiers, such that the second identifier in a unique pair becomes the first identifier for the next unique pair.

9. The method according to claim 6, wherein the identifiers are mapped to known locations in time within the media item.

10. The method according to claim 6, wherein the sequence of identifiers is segmented to allocate a section of the sequence to an individual media item, and a subset of the mapping is used for identification of the media item.

11. The method according to claim 7, wherein the 2M unique identifiers are generated by n-bit codes.

12. An apparatus for encoding identifiers into a media item, comprising:
an encoder device configured to embed a sequence of identifiers equally and in order over a duration of a content of the media item; and
a memory device to store a mapping between the embedded identifiers and the media item;
wherein the sequence of identifiers is created by:
(a) generating a subsequence of 2M unique identifiers, M being an integer greater than one;
(b) shifting every other identifiers in the generated subsequence to the right by two positions in the subsequence and with the identifier at the end cycling around to the corresponding position at the beginning to generate a new subsequence;
(c) repeating step (b) up to M−1 times; and
(d) concatenating the generated subsequences to create the sequence of identifiers.

13. The apparatus according to claim 12, wherein unique pairs of identifiers are formed form the sequence of identifiers, such that the second identifier in a unique pair becomes the first identifier for the next unique pair.

14. The apparatus according to claim 12, wherein the identifiers are mapped to known locations in time within the media item.

15. The apparatus according to claim 12, wherein the sequence of identifiers is segmented to allocate a section of the sequence to an individual media item.

16. The apparatus according to claim 12, wherein the 2M unique identifiers are generated by n-bit codes.

17. An apparatus for decoding a media item that is embedded with a sequence of identifiers equally and in order over a duration of a content of the media item, the apparatus comprising:
a memory device to store a mapping between the embedded identifiers and the media item;
a decoder device configured to detect a pair of identifiers within a predetermined time period, and to identify the media item by indexing the detected pair using the mapping between the embedded identifiers and the media item.

18. The apparatus according to claim 17, wherein the sequence of identifiers is created by:
(a) generating a subsequence of 2M unique identifiers, M being an integer greater than one;
(b) shifting every other identifiers in the generated subsequence to the right by two positions in the subsequence and with the identifier at the end cycling around to the corresponding position at the beginning to generate a new subsequence;
(c) repeating step (b) up to M−1 times; and
(d) concatenating the generated subsequences to create the sequence of identifiers.

19. The apparatus according to claim 17, wherein unique pairs of identifiers are formed form the sequence of identifiers, such that the second identifier in a unique pair becomes the first identifier for the next unique pair.

20. The apparatus according to claim 17, wherein the identifiers are mapped to known locations in time within the media item.
